(19) United States
(12) Patent Application Publication
(10) Pub. No.: US 2005/0093825 A1
(43) Pub. Date: May 5, 2005

(54) Lens structure of optic mouse

(75) Inventors: Wei Chang, San Chung City (TW); Hsien-Yeh Hung, San Chung City (TW); Yuan-Ying Lu, San Chung City (TW)

Correspondence Address: TROXELL LAW OFFICE PLLC, SUITE 1404, 5205 LEESBURG PIKE, FALLS CHURCH, VA, 22041, US

(73) Assignee: UNITY OPTO TECHNOLOGY CO., LTD.

(21) Appl. No.: 10/694,806

(22) Filed: Oct. 29, 2003

(51) Int. Cl. G09G 5/08

(52) U.S. Cl. 345/166

(57) ABSTRACT

An optic mouse includes a casing and a circuit board fixed inside the casing. The casing has a bottom in which a first opening is defined for receiving and fixing a lens module. The lens module includes a support fixed to the first opening and forming a carrier that carries first and second lenses and a reflection portion located adjacent to the second lens and having a top connected to a bottom of the first lens. The circuit board includes a single circuit chip having integrated therewith a light emitter and an optic sensor positioned in correspondence to the first and second lenses, respectively. With the light emitter and the optic sensor integrated in the single circuit chip, the lens module is constructed and arranged to shorten an optic path for a light beam transmitting from the light emitter to the optic sensor whereby the light beam can travel in a more concentrated manner with reduced diffraction and deterioration thereof. Thus, performance of the optic mouse is enhanced.

### FIELD OF THE INVENTION

The present invention generally relates to an optic mouse, and in particular to an optic mouse in which a light emitter and an optic sensor are integrated in a single circuit chip module and a lens module comprising optic elements arranged to shorten an optic path between the light emitter and optic sensor so as to alleviate undesired diffraction and diffusion of the light beam from the light emitter to the light sensor and thus enhancing performance of the optic mouse.

### BACKGROUND OF THE INVENTION

An optic mouse employs optic techniques, including emission and detection of a light beam, to detect moving direction and speed of a computer mouse. An example of the conventional optic mouse is illustrated in FIGS. 5 and 6 of the attached drawings. The conventional optic mouse comprises a bottom plate 6 on which a top casing (not shown) is attached to define an interior space therebetween. A lens assembly 60 and a circuit board 61 are arranged in the interior space. A light emitter or a light source, such as a light-emitting diode (LED) 62, and an optic sensor 63 are mounted to the circuit board 61. The lens assembly 60 is mounted to the bottom plate 6 substantially corresponding in position to the LED 62 and the light sensor 63. The LED 62 emits a light beam that transmits through a first lens 601 of the lens assembly 60 and is then reflected by a reflector 603 of the lens assembly 60 whereby the light beam is projected onto a fixture surface 7, such as a desk and a mouse pad. The fixture surface 7 reflects the light beam back into the mouse whereby the reflected light beam transmits through a second lens 602 of the lens assembly 60 and is focused to the optic sensor 63. The optic sensor 63 detects the light beam and, in response thereto, generates electrical signals that are processed by a circuit formed on the circuit board 61.

The conventional optic mouse requires several separate components or parts, such as the LED 62, the sensor 63 and the lens assembly 60 that is mounted to the bottom plate 6 and operatively associated with the LED 62 and the sensor 63. These components or parts must be manufactured separately and assembled individually to the optic mouse. This is a troublesome and costly process for the parts must be precisely positioned and assembled to realize detection of the light beam traveling along the optic path between the LED 62 and the sensor 63 through all the optic elements mentioned above. Also, costs of the parts themselves are high.

In addition, the lens assembly 60 itself must be structured in a very complicated manner in order to correctly and precisely guide the light beam from the LED 62 through the first lens 601, and redirect the light beam to the fixture surface 7 by the reflector 603. Also, the second lens 602 must be positioned to receive and correctly focuses the light beam reflected by the fixture surface 7 to the optic sensor 63. This arrangement leads to an extended optic path between the LED 62 and the sensor 63 whereby diffraction and deterioration of the light beam occurs in the travel of the light beam from the LED 62 to the optic sensor 63. Thus, the conventional optic mouse suffers from poor performance and high costs and thus does not satisfy the demand of general consumers.

Thus, an optic mouse having improved performance and reduced costs is desired to overcome the drawbacks of the conventional optic mice.

### SUMMARY OF THE INVENTION

Thus, a primary object of the present invention is to provide an optic mouse comprising a single circuit chip module in which a light emitter and an optic sensor are integrated and a lens module comprising optic elements arranged to shorten an optic path between the light emitter and the optic sensor whereby diffraction and deterioration of an optic signal from the light emitter to the optic sensor is alleviated and performance of the optic mouse is enhanced.

To achieve the above object, in accordance with one aspect of the present invention, an optic mouse comprises a casing comprising a top member and a bottom member fixed together, the bottom member defining a first opening, a lens module received in the casing and mounted to the first opening. A circuit board is fixed inside the casing and defines a second opening corresponding in position to the first opening. A circuit chip module is mounted to the second opening. The lens module comprises a support mounted to the first opening. A carrier is formed on the support and carries first and second lenses and a reflection portion formed at a location adjacent to the second lens and having a top portion connected to a bottom of the first lens. The circuit chip module comprises a light source, such as a light-emitting diode, and an optic sensor that are positioned in correspondence to the first and second lenses, respectively.

As such, the light emitter and the optic sensor are integrated in the single circuit chip, while the lens module is constructed and arranged to shorten an optic path for a light beam transmitting from the light emitter to the optic sensor whereby the light beam can travel in a more concentrated manner with reduced diffraction and deterioration thereof. Thus, performance of the optic mouse is enhanced.

### BRIEF DESCRIPTION OF THE DRAWINGS

The present invention will be apparent to those skilled in the art by reading the following description of a preferred embodiment thereof, with reference to the attached drawings, in which:

FIG. 1 is an exploded view of an optic mouse constructed in accordance with the present invention;

FIG. 2 an exploded view of the optic mouse observed from the bottom side thereof;

FIG. 3 is a side elevational view, partially broken, of the optic mouse of the present invention;

FIG. 4 is an enlarged, side elevational view of the optic mouse of the present invention with a portion of a casing of the mouse removed to illustrate an optic path between a light emitter and an optic sensor of the optic mouse of the present invention;

FIG. 5 is an exploded view of a conventional optic mouse with a casing removed; and

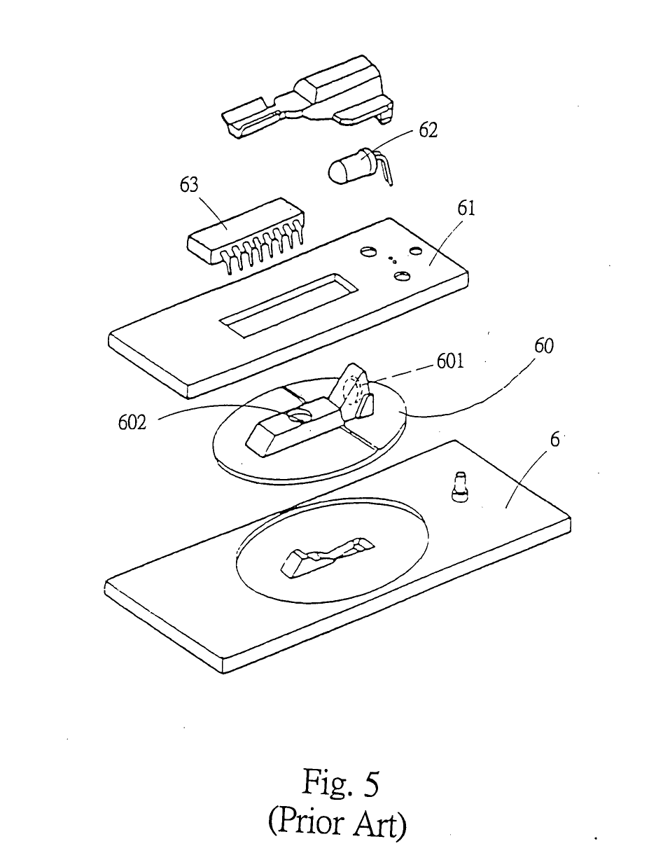

FIG. 6 is a side elevational view of the conventional optic mouse in an assembled condition.

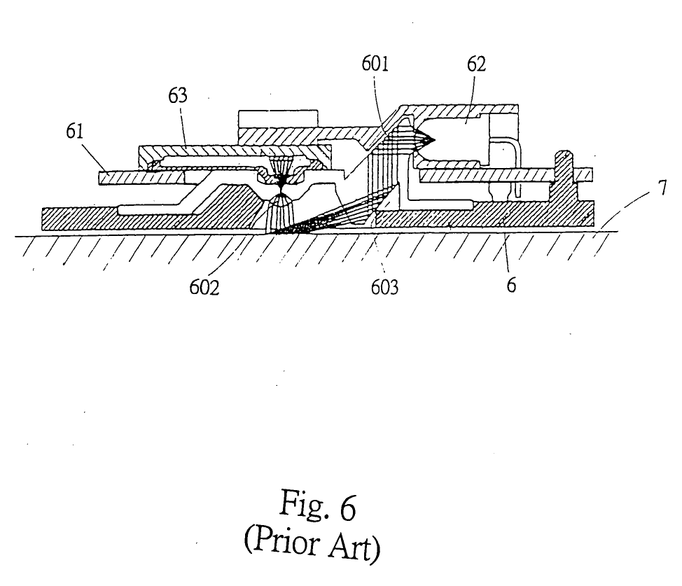

### DETAILED DESCRIPTION OF THE PREFERRED EMBODIMENT

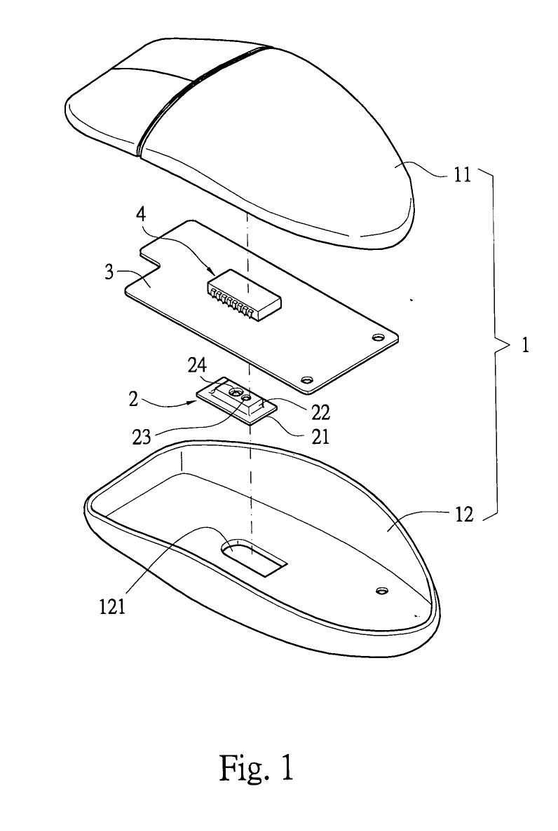

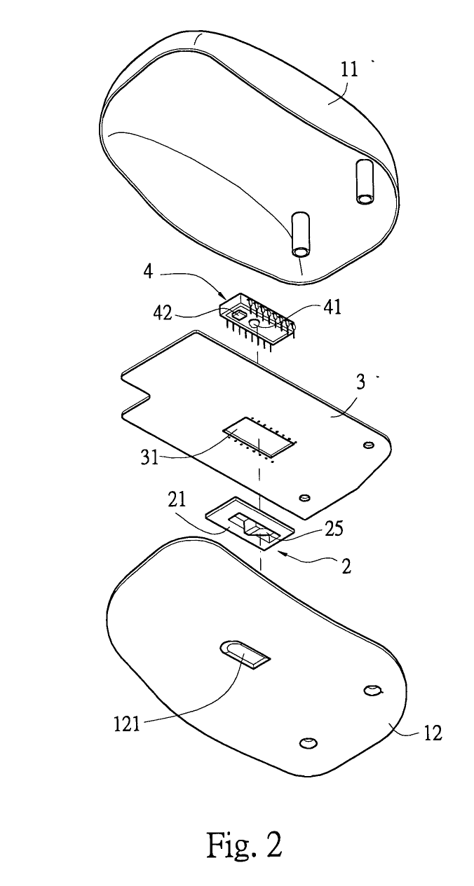

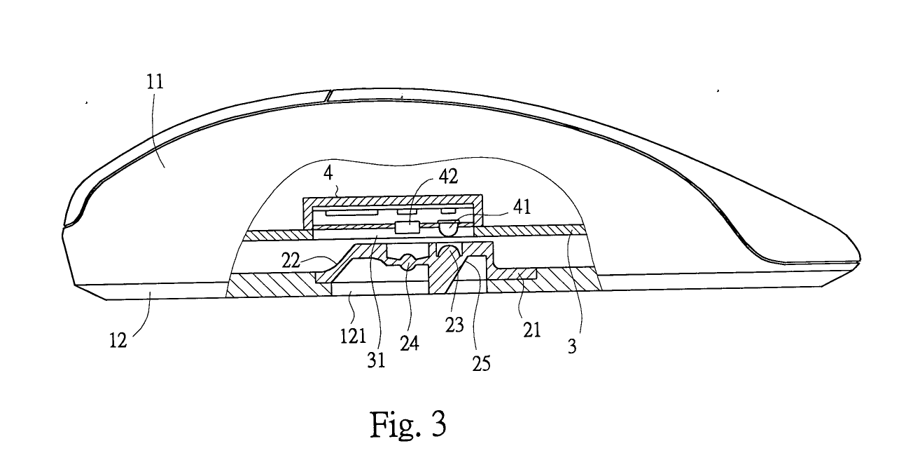

With reference to the drawings and in particular to FIGS. 1-3, an optic mouse constructed in accordance with the present invention comprises a mouse casing 1 to which a lens module 2 is mounted and a circuit board 3 to which a single circuit chip module 4 is mounted. The circuit board 3 is arranged inside the casing 1 to have the circuit chip module 4 positioned substantially corresponding to the lens module 2. The circuit chip module 4 comprises a light emitter or light source 41, such as a light-emitting diode (LED), and an optic sensor 42 integrated therewith. The lens module 2 is constructed and arranged to shorten an optic path for light traveling from the light emitter 41 to the optic sensor 42 whereby diffraction and deterioration of the optic signal during the travel of the light beam is alleviated and the performance of the optic mouse is enhanced.

The mouse casing 1 is comprised of a top casing member 11 and a bottom casing member 12 fixed to each other, defining an interior space inside the casing 1 for receiving the circuit board 3 and the lens module 2. The bottom casing member 12 forms an opening 121 in which the lens module 2 is fixed.

The lens module 2 comprises a support 21 on which a carrier 22 is mounted or integrally formed therewith. The carrier 22 forms and carries first and second lenses 23, 24 that are substantially positioned on the same plane, preferably horizontally, but spaced from each other. A reflection portion 25 is formed in the carrier 22 at a location adjacent to the second lens 24. A top of the reflection portion 25 is spatially corresponding to and connected to a bottom of the first lens 23.

The circuit board 3 is fixed in the casing 1 above the lens module 2. The circuit board 3 defines an opening 31 corresponding in position to the opening 121 of the bottom casing member 12 of the casing 1. The circuit chip module 4 is mounted on the opening 31 with the light emitter 41 and the optic sensor 42 facing the lens module 4 through the opening 31 of the circuit board 3. The light emitter 41 corresponds in position to the first lens 23 for projecting a light beam toward and through the first lens 23, while the optic sensor 42 corresponds in position to the second lens 24 for receiving optic signals transmitting through the second lens 24.

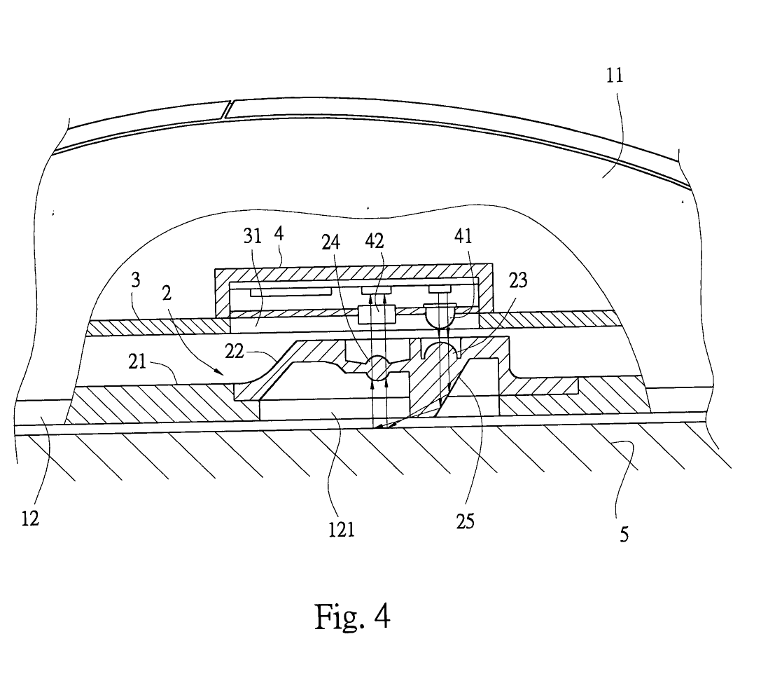

Also referring to FIG. 4, the circuit board 3 comprises a circuit (not shown) that controls the light emitter 41 of the circuit chip module 4 to give off a light beam (as indicated by arrows in FIG. 4) or an optic signal that travels downward to the first lens 23. The light beam transmits through the first lens 23 and travels further downward to the reflection portion 25 that is located under the first lens 23. The reflection portion 25 reflects and redirects the light beam toward a fixture surface 5, such as a desk and a mouse pad, through the opening 121 of the bottom casing member 12 that is positioned on the fixture surface 5.

The fixture surface 5 reflects the light beam in a direction toward the second lens 24 and the second lens 24 receives and focuses the reflected light beam onto the optic sensor 42 that is located above the second lens 24. The optic sensor 42 detects the reflected light beam and, in response thereto, generates electrical signals indicating a moving locus of the optic mouse. Such electrical signals may then be applied to for example a computer system (not shown) to correspondingly move a cursor in a display panel (not shown).

To this point, it is understood that the light emitter 41 and the optic sensor 42 are integrated with a single circuit chip module 4, which simplifies the manufacturing thereof, and which, together with the novel arrangement of the first and second lenses 23, 24 on the same horizontal plane, effectively shortens the optic path along which the light beam travels from the light emitter 41 to the optic sensor 42 thereby alleviating diffraction and deterioration of the light beam occurring during the travel of the light beam from the light emitter 41 to the optic sensor 42. The light beam can be directed to the optic sensor 42 in a more concentrated manner. Performance of the optic mouse is thus enhanced.

Although the present invention has been described with reference to the preferred embodiment thereof, it is apparent to those skilled in the art that a variety of modifications and changes may be made without departing from the scope of the present invention which is intended to be defined by the appended claims.

1. An optic mouse comprising:
a casing comprising a top member and a bottom member fixed together, a first opening being defined in the bottom member;
a lens module received in the casing and mounted to the first opening;
a circuit board fixed inside the casing, the circuit board defining a second opening corresponding in position to the first opening; and
a circuit chip module mounted to the second opening;
the improvements comprising that:
the lens module comprises a support mounted to the first opening, a carrier formed on the support and carrying first and second lenses, and a reflection portion formed at a location adjacent to the second lens and having a top portion connected to a bottom of the first lens; and
the circuit chip module comprises a light source and an optic sensor that are positioned in correspondence to the first and second lenses, respectively.
